(19) United States
(12) Patent Application Publication
(10) Pub. No.: US 2026/0124781 A1
(43) Pub. Date: May 7, 2026

(54) PRESS AND METHOD FOR PRODUCING A CURVED LAMINATED VENEER LUMBER MODULE

(71) Applicant: MODVION AB, Hisings Backa (SE)

(72) Inventor: Leo Anderson, Göteborg (SE)

(21) Appl. No.: 18/705,813

(22) PCT Filed: Oct. 28, 2022
(86) PCT No.: PCT/SE2022/050984

§ 371 Date: Apr. 29, 2024

(30) Foreign Application Priority Data
Oct. 29, 2021 (SE) 2151326-2

(51) Int. Cl. B27D 1/08; B27H 3/00; B32B 21/04; B32B 21/14; E04C 2/12

(52) U.S. Cl. CPC B27D 1/08; B27H 3/00; E04C 2/12; B32B 21/042; B32B 21/14

(57) ABSTRACT

Method and press for producing a curved laminated wood module including a plurality of laminated veneer lumber (LVL) boards, where the press includes a convex mold, where the mold is arranged on a frame, and where the press includes an upper part adapted to be placed on the plurality of LVL boards, where the press further includes a plurality of pulling brackets and pulling means attached between the frame and the pulling brackets, where the pulling means are arranged to pull the pulling brackets towards the frame until the plurality of LVL boards bears completely on the mold.

### TECHNICAL FIELD

The present invention relates to a press and a method for producing a curved laminated veneer lumber (LVL) module comprising a plurality of laminated veneer lumber (LVL) boards. The project leading to this application has received funding from the European Union's Horizon 2020 research and innovation program under grant agreement No 959151.

### BACKGROUND ART

Wood is used for several different constructions and buildings. Wood may either be used as planks or beams sawn in one piece, but is often laminated in one way or the other. One common structural wood element is glued laminated timber (glulam), which consists of layers of dimensional lumber bonded together. These may be used as vertical columns, horizontal beams or arches. Another type of laminated wood is plywood, which consists of a plurality of cross-laminated veneer plies glued to each other. A plywood board is strong, dimension stable and does not warp or bend. Flat plywood boards are pressed in large flat presses, using a high pressure and often a high temperature to cure the glue.

Sometimes, bent laminated veneer materials are used, e.g., in chairs or other smaller objects, where the lamination is done by placing a number of separate veneer layers in a mold and gluing them together in the desired shape in order to obtain the laminated part. This is time consuming and work intensive, and is only suitable for smaller objects. To facilitate the bending of the separate veneer layers, the veneer layers are often treated with steam such that they can be bent without breaking. The pressing of the veneer layers is performed using a high pressure and a high temperature.

When wood is used for larger constructions such as buildings, especially if the building is built on a remote site, it is of advantage to prefabricate as much as possible at a production site where the environmental conditions can be controlled, and to transport larger modules to the building site for assembly. Some wall modules and glulam beams are manufactured in this way.

There is however room for an improved laminated veneer lumber module adapted to be used for curved objects.

### SUMMARY OF INVENTION

An object of the invention is therefore to provide a press for producing a curved laminated veneer lumber module. A further object of the invention is to provide a method for producing a curved laminated veneer lumber module. A further object of the invention is to provide a curved laminated veneer lumber module.

The solution to the problem according to the invention is described in the characterizing part of claim 1 for the press for producing a curved laminated veneer lumber module, in claim 10 for a method for producing a curved laminated veneer lumber module, and in claim 14 for a curved laminated veneer lumber module. The other claims contain advantageous embodiments and further developments of the press and the method for producing a curved laminated veneer lumber module.

In a press for producing a curved laminated wood module comprising a plurality of laminated veneer lumber (LVL) boards, where the press comprises a convex mold adapted to receive the plurality of LVL boards on an outer surface, where the mold is arranged on a frame, and where the press comprises an upper part adapted to be placed on the plurality of LVL boards, such that the plurality of LVL boards are held between the mold and the upper part, where the press further comprises a plurality of pulling members arranged on the long sides of the upper part, where the press comprises pulling means attached between the frame and the pulling members, where the pulling means are arranged to pull the pulling members towards the frame until the plurality of LVL boards bears completely on the outer surface of the mold, the object of the invention is achieved in that the frame comprises a plurality of beams, where each beam is provided with two extendable members arranged at each side of the beam, and where the extendable members are arranged to provide a pressure to the pulling means.

By this first embodiment of a press for producing a curved laminated wood module, a press that can bend and laminate a plurality of LVL boards to a curved laminated wood module is provided. The press comprises a lower part having a mold and a frame, and an upper part that may be provided with a pressure plate. The shape of the mold corresponds to the desired shape of a curved laminated wood module. The LVL boards are placed on the mold one by one with a glue layer between each LVL board. The glue may be applied to an LVL board before the LVL board is placed on the mold, or when an LVL board is positioned on the mold, before the next LVL board is placed on the mold.

When all LVL boards are positioned on the mold, an upper part with or without a pressure plate is placed on the plurality of LVL boards. Pulling brackets arranged on each side of the upper part are pulled towards the frame by pulling means operated by a hydraulic pressure provided from a plurality of hydraulic cylinders. The LVL boards will bend to the curved shape of the mold. When the LVL boards bears completely on the upper surface of the mold, the pressure is held at a constant level until the glue has cured. When the glue has cured and the curved laminated wood module is ready, the pressure is released, such that the curved laminated wood module can be removed from the press.

The press comprises a plurality of beams arranged spaced apart from each other, e.g., with a distance of between 0.5 to 1.0 meters, and perpendicular to a center plane of the press. Each beam is mounted to a floor and comprises two hydraulic cylinders, one at each end of the beam. A hydraulic pump provides the hydraulic pressure to the hydraulic cylinders.

The press may also comprise guide members arranged at each end region of the press, adapted to hold each LVL board in a predefined position. A guide rod will cooperate with a hole or a slit in an LVL board, and will prevent the LVL boards to misplace during the pressing of the curved laminated wood module. The guide rod may be controlled with e.g., a hydraulic cylinder, such that the guide rod can be extended when an LVL board is placed on the stack.

The press may also comprise a support structure arranged to support the flat LVL boards before they are pressed to a module. The support structure is arranged with the bearing surface aligned with the top surface of the mold, such that the LVL boards are held in a flat state. In this way, each LVL board is supported in a flat state, such that glue applied with a glue spreader of some kind can be applied in a controlled manner. By holding the LVL boards in a flat state, the distance between the glue spreader and an LVL board will be constant over the complete LVL board. The support structure can be lowered when glue has been applied to all LVL boards.

The bearing surface of the upper mold may be continuous or may consist of a plurality of spaced apart curved sidewalls. By positioning the sidewalls with a relatively short distance between the sidewalls, e.g., with a distance between 0,5 to 1,0 meters, the pressure between the bearing surface and the upper LVL board will be distributed evenly, since the pack of LVL boards is relatively stiff. It is possible to use an upper pressure plate positioned on top of the upper LVL board to distribute the pressure, depending on the distance between the curved sidewalls.

The mold is in one example removable from the press, and is preferably modular comprising a plurality of sidewalls and support beams. The mold can thus be replaced with another mold when a differently sized curved laminated wood module is to be produced, and by using a mold that is slightly conical, conical curved laminated veneer lumber modules can be produced.

In a method for producing a curved laminated wood module comprising a plurality of laminated veneer lumber (LVL) boards, the steps of: placing one of the plurality of LVL boards on a convex mold arranged on a frame, wherein the frame comprises a plurality of beams, where each beam is provided with two extendable members arranged at each side of the beam, applying a glue layer on the LVL board before the next LVL board is placed on the previous LVL board, until all LVL boards are placed on the mold, placing an upper part on the plurality of LVL boards, pulling the long sides of the upper part towards an outer surface of the mold with pulling means until the plurality of LVL boards bears completely on the outer surface of the mold, where the extendable members are arranged to provide a pressure to the pulling means, holding the plurality of LVL boards pressed against the mold until the glue has cured, releasing the pulling means, and removing the curved laminated wood module from the press are comprised.

By this first embodiment of a method for producing a curved laminated wood module, a curved laminated wood module comprising a plurality of laminated veneer lumber boards is provided. A laminated veneer lumber board comprises a plurality of veneer plies, where most veneer plies are arranged with the wood grain directed in the same direction. The laminated veneer lumber board will also comprise one or two veneer plies arranged with the wood grain directed in a different direction. These plies must be arranged adjacent each other. In this way, the laminated veneer lumber board can be bent to a desired shape without breaking or ripping any of the veneer plies. The veneer ply arranged in a cross direction can be positioned at any position in the laminated veneer lumber board. The laminated veneer lumber board is in one example produced in a symmetric manner, with the ply or plies arranged with the wood grain directed in a different direction positioned in the center of the laminated veneer lumber board.

Normally, a plywood board contains a number of veneer plies arranged in a cross manner, where the wood grain of every other ply is directed in a perpendicular direction. Such plywood boards are produced in large numbers, but cannot be bent without breaking some of the plies. The purpose of arranging every other veneer ply in a perpendicular orientation is to reduce the bending or warping of the plywood, and to provide a flat board. A laminated veneer lumber board contains a number of veneer plies where all veneer plies are arranged with the wood grain in the same direction. Such boards are normally used for construction buildings.

The laminated wood module comprises a plurality of laminated veneer lumber boards and may, depending on the requirements and the thickness of each laminated veneer lumber board, comprise between three to twelve laminated veneer lumber boards or more. The laminated veneer lumber boards are placed in a press having a curved convex mold, where the shape of the mold corresponds to the desired shape of a curved laminated wood module. The laminated veneer lumber boards are placed on the mold, one at the time. On each bearing surface between two laminated veneer lumber boards, glue is applied. A first laminated veneer lumber board is placed on the mold, glue is applied on the first laminated veneer lumber board, a second laminated veneer lumber board is placed on the first laminated veneer lumber board, glue is applied on the second laminated veneer lumber board, etc., until all laminated veneer lumber boards are positioned on the mold. There is no glue applied on the last laminated veneer lumber board. The glue may also be applied to a laminated veneer lumber board before the laminated veneer lumber board is placed in the press.

When all laminated veneer lumber boards are positioned in the press, a pressure plate is places on the laminated veneer lumber boards. A pressure is provided to the press, and pulling members operated by pulling means pull the pressure plate towards the frame, such that the laminated veneer lumber boards are pressed against the mold. When the laminated veneer lumber boards bears completely on the outer surface of the mold, the pressure is held at a constant level until the glue has cured. In one example, the pressure is held at an elevated pressure when the glue of the laminated wood module cures. The required pressure to bend all the laminated veneer lumber boards is e.g., 100 bar. By holding the pressure at e.g., 120 bar during curing, the glue distribution is improved. This may take several hours, depending on the used glue. When the glue has cured and the curved laminated wood module is ready, the laminated wood module will keep its shape, and the pressure can be released, such that the curved laminated wood module can be removed from the press.

The laminated veneer lumber (LVL) boards that are used for the curved laminated wood module may all have the same size, or the size of a laminated veneer lumber board may be adapted to the curvature of the curved laminated wood module. In this case, the first laminated veneer lumber board, which will be the inner surface of a curved laminated wood module, will be slightly narrower than the rest of the laminated veneer lumber boards, and the uppermost laminated veneer lumber board will be the widest. By adapting the width of each single laminated veneer lumber board to the curvature of the curved laminated wood module, less material must be cut or routed away at the side edges after the curved laminated wood module has cured. The laminated veneer lumber boards may also be slightly conical, i.e., one end side of the laminated veneer lumber board is wider than the opposite end side. This will provide curved laminated wood modules that can be used for a conical tower. In this way, less material must be removed after the curved laminated wood module has cured.

A laminated veneer lumber board may preferably comprise between seven to twelve plies of veneer, even if other numbers are also possible. These numbers give a good balance between productivity and usability when creating curved wooden structures comprising several laminated veneer lumber boards. The total number of veneer plies in a board may e.g., depend on the required thickness of a curved module and on the production process. A thinner board is easier to bend, but more separate boards have to be handled which takes more time.

One advantage of the invention is that curved laminated wood modules can be manufactured at a production plant in a rational manner from laminated veneer lumber boards under controlled environmental conditions. The curved laminated wood modules can then be transported to a site for e.g., a wind turbine plant where the curved laminated wood modules are assembled to circular sections and then to a laminated wood tower. The curved laminated wood modules can be manufactured such that they will fit on an ordinary truck, which allows for an easy transport of the curved laminated wood modules. Further, the weight of the curved laminated wood modules is relatively low, which simplifies the transport to remote areas where the roads are often of low quality or non-existent.

It is also possible to provide a curved laminated wood module with an additional outer layer, e.g., a fiber composite material such as a glass fiber or carbon fiber ply or a surface treatment material. The additional outer layer may be applied before a curved laminated wood module is cured, but is preferably applied on the outer surface of the module after curing and shaping of the side edges.

Wood, and especially spruce, pine or birch, is a cheap and strong material suitable to be used for laminating curved laminated wood modules from laminated veneer lumber boards. Other types of laminated boards may also be used, such as laminated veneer boards laminated from bamboo fibers.

### BRIEF DESCRIPTION OF DRAWINGS

The invention will be described in greater detail in the following, with reference to the embodiments that are shown in the attached drawings, in which:

FIG. 1 shows an example of a lower part of a press for laminating a curved laminated wood module according to the invention,

FIG. 2 shows a detail of the press for laminating a curved laminated wood module according to the invention,

FIG. 3 shows an example of an upper part of a press for laminating a curved laminated wood module according to the invention,

FIG. 4 shows an example of a press for laminating a curved laminated wood module with a first LVL board according to the invention,

FIG. 5 shows an example of a press for laminating a curved laminated wood module with an upper part according to the invention,

FIG. 6 shows a detail of the press for laminating a curved laminated wood module according to the invention,

FIG. 7 shows an example of a press arranged for laminating a wide curved laminated wood module before pressing,

FIG. 8 shows an example of a press arranged for laminating a wide curved laminated wood module during pressing,

FIG. 9 shows an example of a press arranged for laminating a narrow curved laminated wood module before pressing, and

FIG. 10 shows an example of a press arranged for laminating a narrow curved laminated wood module during pressing.

### DETAILED DESCRIPTION OF THE DRAWINGS

The embodiments of the invention with further developments described in the following are to be regarded only as examples and are in no way to limit the scope of the protection provided by the patent claims.

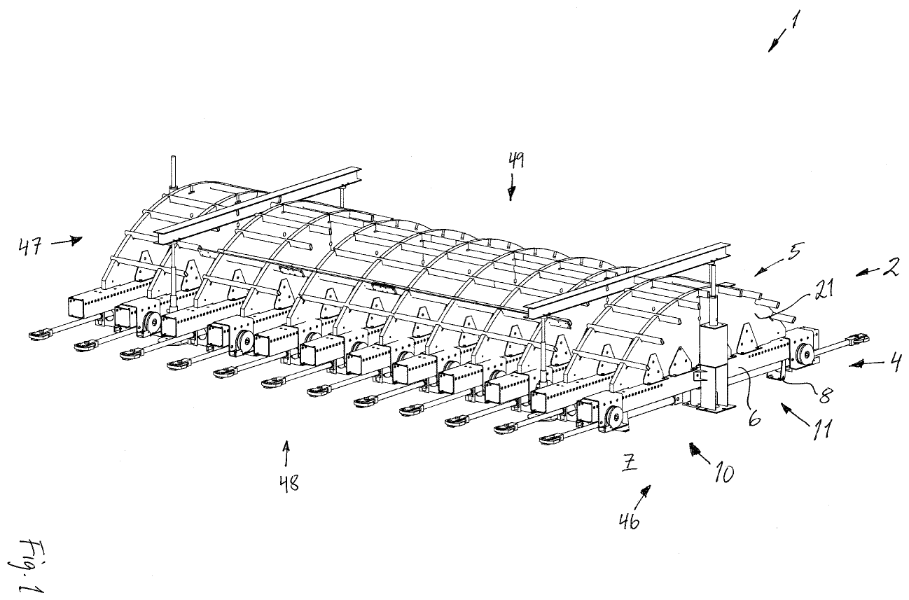

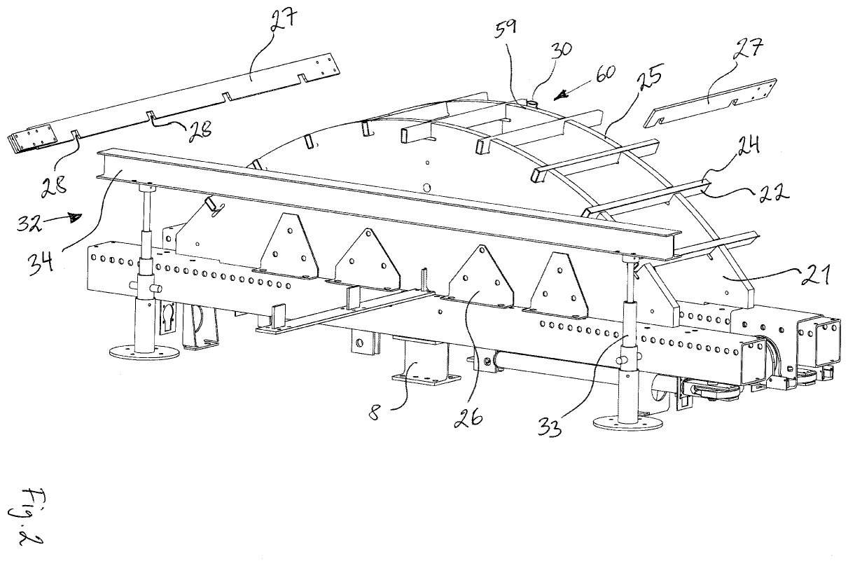

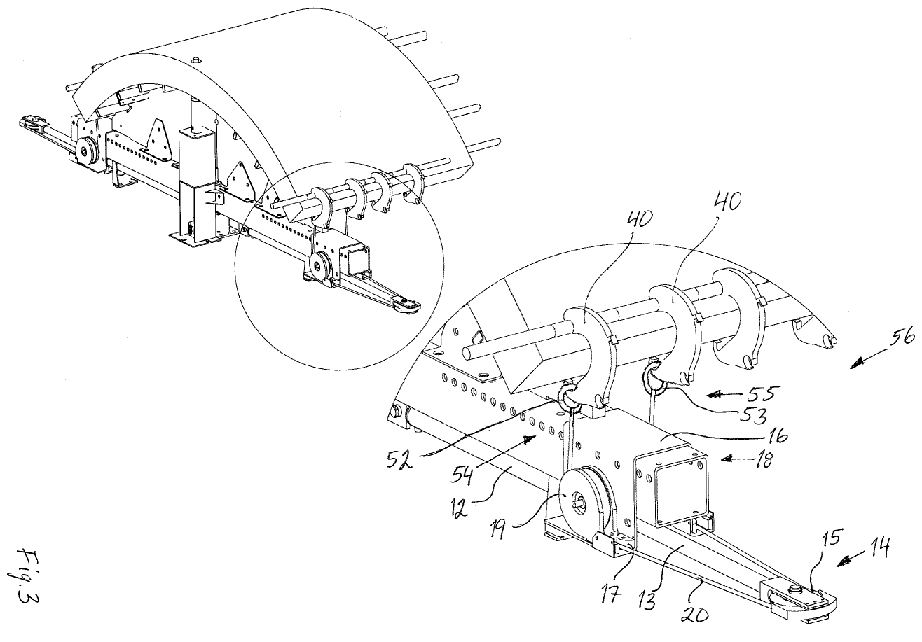

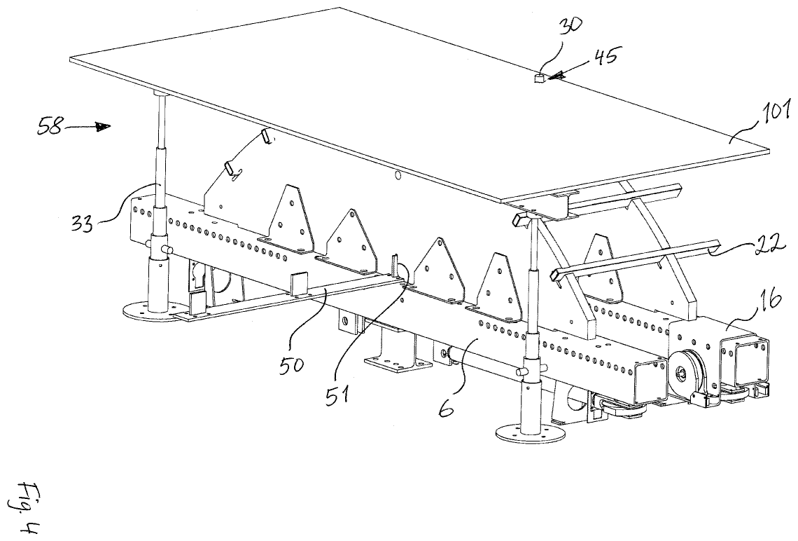

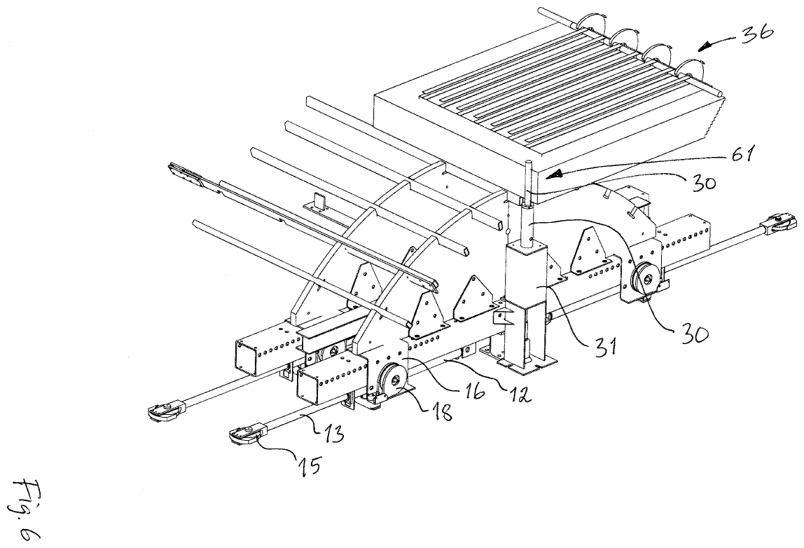

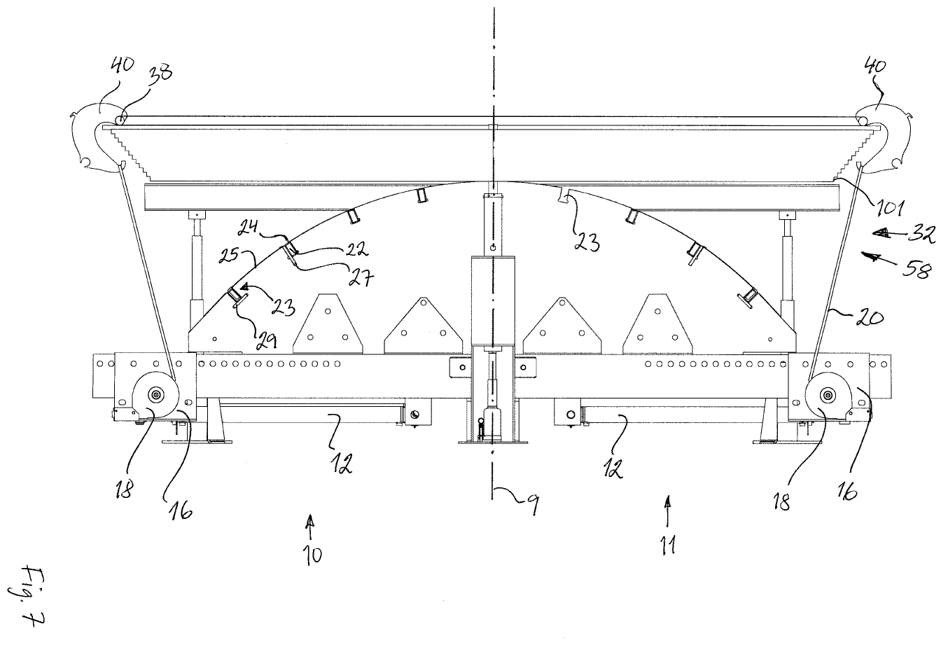

FIGS. 1 to 6 show various examples and details of a press 1 for producing a curved laminated wood module 100 from a plurality of laminated veneer lumber (LVL) boards 101, and FIGS. 7 to 10 show examples of the pressing of a curved laminated wood module 100. The press 1 comprises a lower part 2 and an upper part 3. The lower part 2 comprises a frame 4 and a mold 5 arranged on the frame. The press is provided with a first end 46, a second end 47, a first longitudinal side 48 and a second longitudinal side 49. The frame provides the stability for the press and comprises in the shown example a number of longitudinal beams 6 arranged perpendicular to a center plane 9 of the press. The beams 6 are in the shown example mounted on a floor 7 with mounting brackets 8 at the manufacturing site, but could also be attached directly to each other with additional crossbeams. The press is adapted to press large curved laminated wood modules, where one example of a module is 20 meters long and 4 meters wide. The press is suited to press modules e.g., between 10 to 30 meters long and 2 to 5 meters wide, depending on the number of used beams and the used mold.

The press may be designed for one size of a curved module, or may be designed to press curved modules of different sizes and different curvatures. In the shown example, a press adapted for differently sized curved modules is shown. Each beam 6 is attached to the floor 7 with mounting brackets 8. The press is symmetrical with respect to the center plane 9 of the press, having a left side 10 and a right side 11. The beam is provided with an extendable member 12, in the shown example a hydraulic cylinder, having a piston 13. The cylinder will provide the pulling force required to bend the plurality of LVL boards to form a curved laminated wood module 100, and to press the plurality of LVL boards together to a solid unit. At the outer end 14 of the piston 13, a first pulley wheel or sheave 15 is mounted. The beam is further provided with a movable adjustment bracket 16 that can slide along the beam and that is fixed in position on the beam with fixating members, such as pins or bolts.

The adjustment bracket 16 is on one side provided with a second pulley wheel 18 and on the other side with a third pulley wheel 19. The first pulley wheel 15, the second pulley wheel 18 and the third pulley wheel 19 are adapted to guide a flexible pulling means 20, such as a wire, rope, cable or chain. A line guide 17 is positioned next to the second and third pulley wheels 18, 19, between the second and third pulley wheels 18, 19 and the first pulley wheel 15. The line guide will ensure that the pulling means is aligned with the second and third pulley wheel in a straight direction, regardless of the position of the first pulley wheel. The surface of the line guide is smooth such that the pulling means can glide against it without damage.

The pulling means is routed from a pulling bracket 40, in the shown example a curved pulling bracket of the upper part 3, over the second pulley wheel 18, the first pulley wheel 15 and the third pulley wheel 19 to another pulling bracket 40. In one preferred example, the pulling means is an ultra-high-molecular-weight polyethylene (UHMWPE) wire, such as a dyneme wire. Such a wire is light, strong and very flexible. One advantage of using a light wire is that the risk of damage is reduced if the wire would break, since it stores less energy compared to a metallic wire. A first end 54 of the pulling means 20 is in one example provided with a first attachment means 52, e.g., in the form of an eye or a shackle, that is attached to a pulling bracket 40, and a second end 55 of the pulling means is provided with a second attachment means 53, e.g., in the form of an eye or a shackle, that is attached to another pulling bracket 40. In this way, the attachment of the pulling means to the pulling brackets is simplified.

The press comprises a plurality of identical beams 6 arranged side by side with the same distance between them along the length of the press. The distance between two beams may e.g., be 0.5 or 0.75 meters, such that a 20 meter long press comprises between 30-40 beams. The number of beams used for a press is determined e.g., by the required pressing force and the used mold.

The mold 5 is mounted to the frame 4 of the press with several mounting brackets 26. The mold comprises a plurality of curved sidewalls 21 provided with longitudinal support beams 22 arranged in slits 23 in the sidewalls. The radius of a sidewall 21 is at least 1 meter, and is preferably in the range between 2 to 4 meters, depending on the desired curvature of a curved laminated wood module 100. The outer side edge 24 of a support beam 22 is aligned with the outer curved surface 25 of the sidewalls. In this way, the support beams will help to distribute the force between the LVL boards and the sidewalls of the mold during pressing. The shown mold comprises twelve support beams 22, but other numbers are of course also possible, depending e.g., on the size of the mold and the thickness of the curved laminated wood module. The length of a support beam may be shorter than the press, such that several support beams are used to cover the length of the press.

The mold further comprises two or more distance beams 27 provided with spaced apart cut-outs 28. The width of a cut-out corresponds to the thickness of a sidewall 21 and the distance between two cut-outs corresponds to the longitudinal distance between two sidewalls. The purpose of the distance beams is to ensure that the upper parts of the sidewalls are held in a correct position and do not displace or deform during pressing. A distance beam is arranged in a slit 23 with a width that corresponds to the width of both a support beam 22 and a distance beam 27. The height of a distance beam is larger than the height of a support beam, such that the sides of a cut-out will bear in the sides of a sidewall. The length of a distance beam preferably corresponds to the length of the press, such that a distance beam can support all sidewalls of the press. Part of a distance beam may be removed when the LVL boards are placed on the press, in order to make room for a holding beam 34. When all LVL boards are placed on the press and the holding beam has been lowered, the distance beam is in this case reassembled.

The bottom of a slit 23 may also be provided with a reinforcement member 29. The reinforcement member is adapted to distribute the pressure from a support beam 22 to a larger area at the bottom region of a slit. The reinforcement member may be a flat metal part, e.g., 5- 10 mm thick, that is inserted in a widened bottom slit of the slit 23. The length of a reinforcement member is e.g., two to three times the width of a support beam. The reinforcement member will prevent the bottom of a slit 23 to be deformed by the pressure acting on a support beam, such that wear on the sidewall is reduced. In the shown example, the lowermost slit 23 is provided with a reinforcement member. This is due to the fact that this support beam is exposed to the highest forces.

Each sidewall 21 is attached to a beam 6 by attachment brackets 26. The attachment brackets will hold the sidewalls on the beams in a fixedly manner, such that the sidewalls will not displace or misalign during the pressing of a curved wood module. The sidewalls are attached in a removable manner, e.g., with screws or pins, such that the sidewalls can be removed and other sidewalls can be attached to the beams when a differently sized mold is to be used. The brackets can preferably also be removable mounted on a beam which is of advantage, e.g., if a larger mold requiring more brackets is to be attached to the beams. The press further comprises a central alignment beam 50 that will center each sidewall through a central slit 51 in the sidewall. This simplifies the attachment of a sidewall to a beam when assembling the mold.

The press is adapted to produce curved laminated wood modules 100, either straight modules or modules with a conical shape. The press can thus be provided with either a straight mold or a mold having a conical shape. In a straight mold, all sidewalls have the same size and shape. In a mold for conical curved wood modules, the sidewalls will differ somewhat in size, starting with the largest sidewall at one end of the mold and ending with the smallest sidewall at the other end of the mold. By using separate, replaceable sidewalls, each sidewall may be used for several different molds. One sidewall may e.g., be used as the smallest sidewall for one mold, as an intermediate sidewall in another mold and as the largest sidewall in yet another mold. This simplifies the design and storing of the molds.

The shown press further comprises guide members 30 arranged at each end region 46, 47 of the press. The guide members are arranged to position each LVL board 101 in a longitudinal and transverse correct position during the placing of each LVL board on the press, and to hold the LVL boards in this position during pressing, such that the LVL boards do not misplace during pressing. Without the guide members, there is a risk that the LVL boards may glide to one side due to an uneven initial pressing force or due to gravity. The guide member may have different shapes, and is in the shown example a circular rod, and is arranged at each end region 46, 47 of the press. Each LVL board comprises an opening 45, in the shown example a circular hole, at each end that corresponds to the guide member 30.

The guide member is arranged in a movable manner, such that it can extend over the complete curved laminated wood module 101 and over the upper part 3 in an extended position 61, and such that it can be retracted to a lower position 60 below the uppermost bearing surface 59 of the mold. The shown circular rod is provided on a hydraulic cylinder 31 attached to the outermost beam at each end of the frame 4. A guide member will cooperate with an opening 45 or a slit in an LVL board. The guide member may be controlled such that the guide member is extended with a distance corresponding to the thickness of an LVL board when a laminated veneer lumber board is placed on the stack. In this way, the guide member will position and hold each LVL board in the correct position without extending over the upper surface of the LVL board. This will facilitate e.g., the use of a glue spreader that runs over each LVL board when glue is applied on each LVL board. It is also possible to use a fixed guide member.

The shown press also comprise at least two holding structures 32 arranged to support the flat LVL boards before they are pressed to a curved laminated wood module. The number of used support structures depend e.g., on the length of the press and on the thickness of the used LVL boards. The support structure 32 is in a raised position 58 arranged with the bearing surface aligned with the uppermost bearing surface 59 of the mold, such that the LVL boards are held in a flat state. In this way, each LVL board is supported in a flat state, such that glue applied with a glue spreader of some kind can be applied in a controlled manner. By holding the LVL boards in a flat state, the distance between the glue spreader and a LVL board will be constant over the complete LVL board. A support structure 32 comprises at least two legs 33 arranged at the longitudinal sides 48, 49 of the press. It is possible to let the upper side of a leg be aligned with the uppermost bearing surface 59 of a sidewall, such that a horizontal holding plane is provided when the LVL boards are placed on the press. The support structure 32 may also be provided with a holding beam 34 that is arranged on the legs 33. In this case, the upper side, i.e., the bearing surface, of the holding beam is aligned with the uppermost bearing surface 59 of a sidewall. The legs may be fixed, or may be arranged on a cylinder that can be extended and lowered by e.g., hydraulic pressure. One advantage with expandable legs is that the height of the support structure can be adapted to the height of the mold, which may differ depending on the size of a curved laminated wood module. In a lowered position 57, the holding structure 32 is out of the way, and is e.g., aligned with a beam 6 of the frame 4. The holding beam 34 and the legs 33 may also be removed from the press.

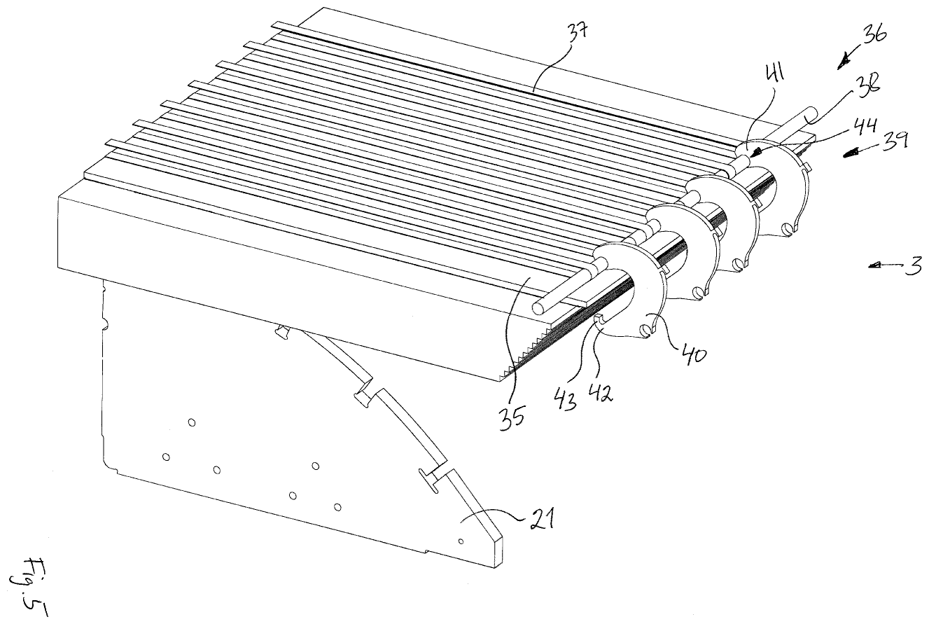

The press further comprises an upper part 3, partly shown in FIG. 5. The upper part 3 comprises a pressure distribution unit 36 that will provide an even pressure on the curved laminated wood module through the pulling means 20. The pressure distribution unit 36 comprises a load distributing arrangement 37, in the shown example a plurality of straps, interconnecting two load bearing members 38, in the shown example two circular rods, where each rod is arranged at a longitudinal side edge 39 of the upper part 3. To each rod, there is attached a number of pulling brackets 40 to which the pulling means 20 of each beam are attached when a curved laminated wood module is to be pressed. There are two pulling brackets 40 at each side of the press for each beam 6. A pulling bracket 40 is curved and comprises a first end 41 pivotably attached to the rod 38 and a second end 42 provided with a hook 43. The pulling means 20 are attached to the hooks of the pulling brackets either directly or through attachment means 52, 53, e.g., shackles or eyes. In this way, the pulling means 20 can easily be attached to the pulling brackets when a new curved laminated wood module is to be pressed or removed from the pulling brackets when a curved laminated wood module is ready.

The pulling bracket 40 is in the shown example attached to a rod 38. The pulling bracket is at a first end 41 provided with a circular opening 44 that corresponds to the diameter of the rod. When the pulling brackets are attached to the rod, each pulling bracket is threaded onto the rod and pushed to the desired position. When all pulling brackets are positioned, the straps can be applied. At a second end 42, the pulling bracket is in the shown example provided with a hook 43 arranged to receive the pulling means, either directly or through a shackle or the like. A hook 43 allows the pulling means to be easily attached and detached, which simplifies the attachment of the upper part to the lower part of the press. The second end could also be provided with a hole arranged to receive a shackle, hook or the like. The pulling bracket is provided with a curved shape, somewhat resembling a C. This allows the first end 41 of the pulling bracket to apply the pulling force at a distance from the side edge 39 of the LVL boards. This distance is preferably larger than 10 cm. This will also allow the pulling bracket to rotate on the rod during the pressing of a laminated wood module, since the position of the pulling bracket will move inwards during the pressing.

The curved shape of a pulling bracket allows the pulling bracket to rotate freely with respect to the rod when a module is pressed and when the rod and the pulling brackets are pulled towards a beam. There is one pair of pulling brackets for each beam end. The curved shape of the pulling bracket 40 allows the pressure from the pulling means 20 to be applied at a small distance from the longitudinal side edges of the module, e.g., 10-20 centimeters from a side edge. This will provide an even pressure distribution at the side edge of the curved laminated wood module, which will prevent the edge of a curved laminated wood module to be deformed. This will further provide an even force distribution in the straps 37 interconnecting the rods and thus the pulling brackets, which will also help to distribute the pressure force in an even manner, reducing the risk of a deformed curved laminated wood module. When the force is applied directly on the edge, there will be a force component pushing inwards on the edge of the upper LVL boards, which will deform at least the outer part of the edge.

The load bearing member may also be e.g., a rectangular beam to which a pulling bracket is attached by e.g., a hinge or the like. It is important that the pulling bracket is curved such that the load bearing member can be positioned at a distance from the outer edge of the LVL boards. The load distributing arrangement may also be provided in other ways. It is important that the load distributing arrangement distributes the applied pressure evenly over the complete surface of the LVL boards. In the shown example, a number of adjustable straps are used. It is also possible to use a woven fabric of some sort having loops for the load bearing member, or the load bearing member may be fixedly attached to a flexible sheet or board, e.g., a metal sheet.

The upper part 3 may also comprise a pressure plate 35 which can act as a lid for the press and which can distribute the pressure over the complete module that is pressed. The pressure plate may further hold and position the pressure distribution unit 36 such that the load distributing arrangement 37 and the load bearing members 38 can be handled as one piece. A further advantage of using a pressure plate is that the force acting on the curved laminated wood module will be vertical, such that there is no bending moment acting on the module. An uneven pressure may result in uneven glue layer thicknesses when pressing the curved laminated wood module. This is also a reason to apply the pressure at a small distance from the side edge of the LVL boards.

The two rods 38 of the upper part 3 are connected with a load distributing arrangement 37 that will keep the distance between the rods and that will distribute the applied force over the surface of the upper LVL board. In the shown example, the load distributing arrangement 37 comprises a plurality of straps arranged in a closed loop between the two rods. The shown straps are two-piece tie-down straps that can be adjusted in length. In this way, it is easy to adjust the length of each strap to the desired length, e.g., when a conical laminated wood module is pressed, or to replace a strap if it is damaged. It is also possible to use loop straps having a fixed length. It would also be possible to use a single heavy cloth, e.g., a tarpaulin or the like, provided with loops at the longitudinal sides to hold the rods.

FIG. 7 shows a press 1 with a plurality of LVL boards 101 that are to be pressed to a curved laminated wood module 100. Each LVL board is coated with a glue of some kind that will bond adjacent boards to each other when the curved laminated wood module is pressed. The pressing is made at room temperature, i.e., cold pressing, there is thus no need to heat the LVL boards during pressing. When pressing thick laminated wood modules, it is difficult to heat the complete module evenly since the heat is applied from the outside and wood does not transfer heat very well. Laminated wood modules having a thickness of more than 150 mm are thus impractical to press with a heat press method, and much thicker laminated wood modules cannot be pressed at all. The advantage of cold pressing is the simplicity, the drawback of the prolonged curing time for the glue.

The LVL boards used in this example is a laminated veneer lumber board where the wood grain direction of all veneer plies are directed in the same direction except for one or two adjacent veneer plies where the wood grain is directed in a perpendicular direction. The veneer plies having a different direction may be positioned at any position in the LVL board, and is in one example positioned in the center of the LVL board. In one example, the LVL board consists of four veneer plies with the wood grain direction in a first direction, one ply with the wood grain direction in a perpendicular direction, and four veneer plies with the wood grain direction in a first direction, i.e., a nine veneer ply board. LVL boards having only a single position with a crosswise arranged veneer ply are suitable for bending without breaking any of the veneer plies. A laminated wood module may e.g., comprise eight such LVL boards, depending on the intended use. It is of course possible to use conventional LVL boards, where all veneer plies are oriented with the same wood grain direction, e.g., if a circular laminated wood tube is produced.

The advantage of using LVL boards for the curved laminated wood modules is that the lamination can be made without an additional heating of the wood module. When LVL boards are laminated from veneer plies, a high temperature and a high pressure is required to laminate the LVL board. This is due to the fact that the used glue requires heat to set in a relatively short time. When using an LVL board adapted to be used for curved laminated wood modules, additional heat, steam or other pre-treatments are not necessary which simplifies the pressing considerably. A short curing time for an LVL boards is crucial for an efficient production, but the curing time for a curved laminated wood module is not very important. A typical curing time may be e.g., 8 hours.

The LVL boards are placed on the mold, one at the time. On each bearing surface between two LVL boards, glue is applied. A first LVL board is placed on the mold 5 and on the holding structure 32, glue is applied on the first LVL board, a second LVL board is placed on the first LVL board, glue is applied on the second LVL board, etc., until all LVL boards are positioned on the mold. There is no glue applied on the last LVL board. The glue may be applied with e.g., a spray head or a roller in order to ensure that the right amount of glue is applied. The glue may also be applied to an LVL board before the LVL board is placed in the press.

When all laminated veneer lumber boards that are required for a curved laminated wood module 100 are positioned on the mold in the press, the upper part 3, with or without a pressure plate 35, is placed on the LVL boards. The holding structure 32 is lowered from the raised position 58 to the lowered position 57. The pressure plate may also comprise holes or slits that are adapted to cooperate with the guide members 30. With the upper part in place, the press is ready for pressing a curved laminated veneer lumber module. Each pulling means 20 is attached to the hook 43 of the corresponding pulling bracket 40. FIG. 7 shows an example of the press before the pressing of a curved laminated wood module is started. In the shown example, a relatively wide curved laminated wood module is pressed. The adjustment brackets 16 are here attached to an outer end of the beam 6, such that the distance between the pulley wheels 18, 19 of the pulling system 56 allows for a wide curved laminated wood module to be produced. A corresponding wide mold 5 is mounted to the frame.

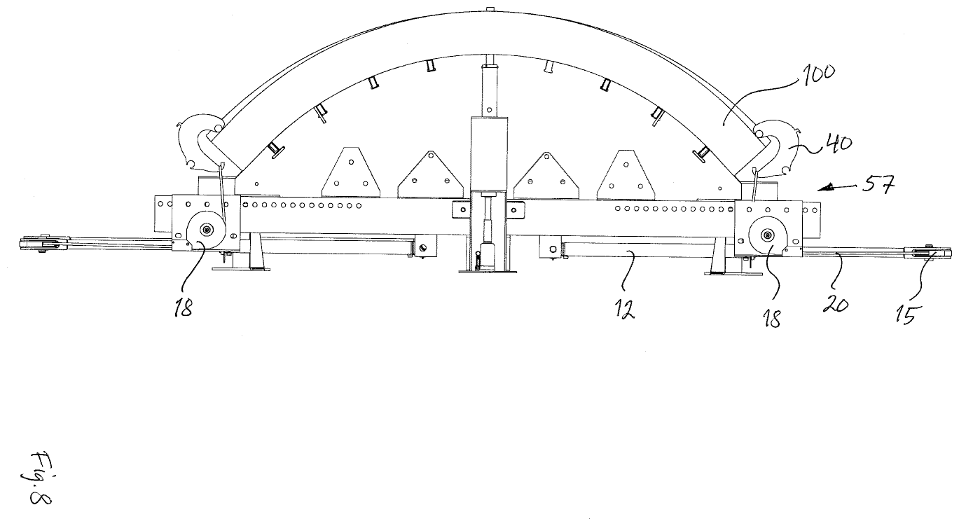

The pressing of a curved laminated wood module 100 is in the shown example performed by the use of the hydraulic cylinders 12. A pressure is applied to the hydraulic cylinders, which pushes the pistons 13 out of the cylinder. The first pulley wheel 15 will, when pressure is applied, self-center the piston such that is does not rotate in the hydraulic cylinder. This will in turn pull the pulling brackets 40 downwards, towards the beam 6. Two pulling brackets are pulled down by one hydraulic cylinder. Pressure is applied to the hydraulic cylinders until the LVL boards bears on the complete outer surface of the mold 25, as shown in FIG. 8. All hydraulic cylinders of the press may be connected to the same pressure source. In this way, the pulling pressure of each hydraulic cylinder will balance the other cylinders until all pulling brackets press the LVL boards to the mold with the same pressure. When the LVL boards bears completely on the outer surface of the mold, the pressure is held at a constant level until the glue has cured. This may take several hours, depending on the used glue. When the glue has cured and the curved laminated wood module is ready, the pressure is released. It would also be possible to apply the pulling pressure with other pulling means, such as rotational electric motors or linear electric motors.

In one example, the pressure is held at an elevated pressure when the glue of the laminated wood module cures. The required pressure to bend all the laminated veneer lumber boards is e.g., 100 bar. By holding the pressure at e.g., 120 bar during curing, the glue distribution is improved.

When the glue has cured, the pressure is released from the hydraulic cylinders and each piston returns to its inner starting position. If a single-acting cylinder is used, the piston is returned by an external force, e.g., an external spring. If a double acting cylinder is used, a pressure is applied to the other side of the piston such that the piston returns to the start position. The pulling means are unhooked from the pulling brackets, the upper part is removed from the press and the curved laminated wood module can be removed from the press and forwarded to a station in which e.g., the sides of the curved laminated wood module are shaped.

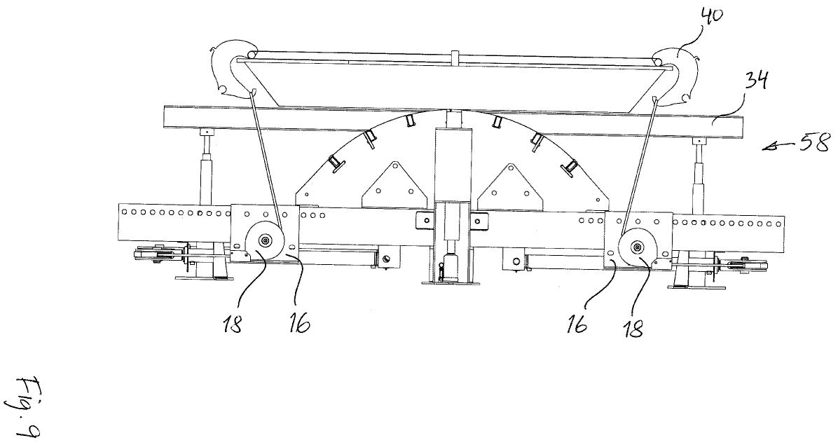

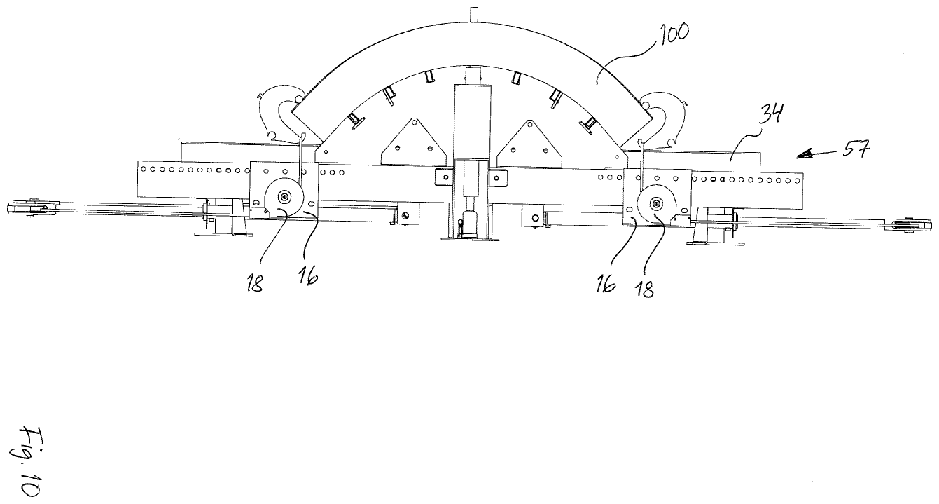

In FIGS. 9 and 10, an example is shown in which a narrow curved laminated wood module is pressed. Here, the adjustment brackets 16 are attached to the beam in a position close to the center plane 9 of the press, such that the distance between the pulley wheels 18, 19 of the pulling system 56 allows for a narrow curved laminated wood module to be produced. At the same time, a corresponding smaller mold 5 is mounted to the frame.

The LVL boards that are used for the curved laminated wood module may all have the same size, or the size of an LVL board may be adapted to the curvature of the curved laminated wood module. In this case, the first LVL board, which will be the inner surface of a curved laminated wood module, will be slightly narrower than the rest of the LVL boards, and the uppermost LVL board will be the widest. By adapting the width of each single LVL board to the curvature of the curved laminated wood module, less material must be cut or routed away at the side edges after the curved laminated wood module has cured. The LVL boards may also be slightly conical, i.e., one end side of the LVL board is wider than the opposite end side. This will provide curved laminated wood modules that can be used for a conical tower. In this way, less material must be removed after the curved laminated wood module has cured.

An LVL board may preferably comprise between seven to twelve plies of veneer, even if other numbers are also possible. These numbers give a good balance between productivity and usability when creating curved wooden structures comprising several LVL boards. The total number of veneer plies in an LVL board may e.g., depend on the required thickness of a curved laminated wood module and on the production process. A thinner LVL board is easier to bend, but more separate LVL boards have to be handled which takes more time. A wooden structure comprises a plurality of curved laminated wood modules mounted to each other. A wooden structure is preferably circumferential with a closed periphery, e.g., a circular structure such as a tower. A closed structure will be rigid enough even though the wood grain of most of the veneer plies are directed in the same direction.

An LVL board is made from several veneer plies of thin wood. A veneer ply may be e.g., between 2-4 mm thick, and an LVL board may comprise between 7 to 15 veneer plies. The number of used LVL boards and the number of veneer plies in an LVL board depends on the forces that the final construction must handle.

One advantage of the invention is that curved laminated wood modules can be manufactured at a production plant in an efficient manner from LVL boards under controlled environmental conditions. The curved laminated wood modules can then be transported to a site for e.g., a wind turbine plant where the curved laminated wood modules are assembled to circular sections and then to a laminated wood tower. The curved laminated wood modules can be manufactured such that they will fit on an ordinary truck, which allows for an easy transport of the curved laminated wood modules. Further, the weight of the curved laminated wood modules is relatively low, which simplifies the transport to remote areas where the roads are often of low quality or non-existent.

It is also possible to provide a curved laminated wood module with an additional outer layer, e.g., a fiber composite material such as a glass fiber or carbon fiber ply or a surface treatment material. The additional outer layer may be applied before or after a curved laminated wood module is cured.

Wood, and especially spruce, pine or birch, is a cheap and strong material suitable to be used for laminating curved laminated wood modules from LVL boards. Other types of laminated boards may also be used, such as laminated veneer boards laminated from bamboo fibers.

In the method for producing a curved laminated veneer lumber module, several LVL boards are pressed together in a press, such as a press as described above, where the final shape of the curved laminated wood module is obtained.

In a first step, a plurality of LVL boards are placed on a mold of the press. Glue is applied between each LVL board, such that the LVL boards can be glued together. The glue is preferably applied on the upper surface of an LVL board when it lays in the press, before the next LVL board is placed on the previous LVL board. The glue may also be applied to an LVL board before the LVL board is placed in the press.

When all LVL boards are positioned on the mold, the LVL boards can be pressed to a curved laminated wood module. It would also be possible to place and glue all LVL boards on each other outside of the press, and then to place the package of LVL boards in the press. Pressure is applied to the hydraulic cylinders, such that the pulling means pull the pulling brackets towards the frame of the press. This will pull the LVL boards towards the mold. When the LVL boards bears completely on the mold, the bending action is completed, and the pressure is held at a constant level until the glue has cured.

When the glue has cured completely, the pressure is released. The curved laminated wood module can now be removed from the press. The curved laminated wood module can be lifted by a traverse or a crane.

The invention is not to be regarded as being limited to the embodiments described above, a number of additional variants and modifications being possible within the scope of the subsequent patent claims.

1. A press for producing a curved laminated wood module comprising a plurality of laminated veneer lumber (LVL) boards, the press comprising:
a convex mold adapted to receive the plurality of LVL boards on an outer surface, where the mold is arranged on a frame;
an upper part adapted to be placed on the plurality of LVL boards, such that the plurality of LVL boards are held between the mold and the upper part, wherein the upper part comprises a plurality of pulling brackets arranged at the long sides of the press; and
pulling means attached between the frame and the pulling brackets, where the pulling means are arranged to pull the pulling brackets towards the frame until the plurality of LVL boards bears completely on the outer surface of the mold,
wherein the frame comprises a plurality of beams, where each beam is provided with two extendable members arranged at each side of the beam, and where the extendable members are arranged to provide a pressure to the pulling means.

2. The press according to claim 1, wherein an extendable member is a hydraulic cylinder arranged to provide a hydraulic pulling pressure to the pulling means.

3. The press according to claim 1, wherein an extendable member is an electric motor arranged to provide a pulling pressure to the pulling means.

4. The press according to claim 1, wherein the press is longitudinal with a length between 10-30 metres and a width between 2-5 meters.

5. The press according to claim 1, wherein the mold is removably attached to the frame.

6. The press according to claim 1, further comprising at least one guide member arranged at each end region of the press.

7. The press according to claim 1, wherein the mold is provided with a conical shape.

8. The press according to claim 1, wherein the pulling means is attached to an adjustment bracket arranged on the frame in a movable manner, such that the position of the adjustment bracket can be changed.

9. The press according to claim 1, wherein the upper part further comprises a pressure plate.

10. A method for producing a curved laminated wood module comprising a plurality of laminated veneer lumber (LVL) boards, the method comprising the steps of:
placing one of the plurality of LVL boards on a convex mold arranged on a frame, wherein the frame comprises a plurality of beams, where each beam is provided with two extendable members arranged at each side of the beam;
applying a glue layer on the LVL board before the next LVL board is placed on the previous LVL board, until all LVL boards are placed on the mold;
placing an upper part on the plurality of LVL boards;
pulling the long sides of the upper part towards an outer surface of the mold with pulling means until the plurality of LVL boards bears completely on the outer surface of the mold, where the extendable members are arranged to provide a pressure to the pulling means;
holding the plurality of LVL boards pressed against the mold until the glue has cured;
releasing the pulling means; and
removing the curved laminated wood module from the press.

11. The method according to claim 10, wherein the pulling means is operated by hydraulic pressure.

12. The method according to claim 10, wherein the press comprises a plurality of hydraulic cylinders acting on the pulling means and connected to the same hydraulic pressure source to provide the pulling force.

13. The press according to claim 2, wherein the mold is removably attached to the frame.

14. The press according to claim 3, wherein the mold is removably attached to the frame.

15. The press according to claim 2, further comprising at least one guide member arranged at each end region of the press.

16. The press according to claim 3, further comprising at least one guide member arranged at each end region of the press.

17. The press according to claim 2, wherein the pulling means is attached to an adjustment bracket arranged on the frame in a movable manner, such that the position of the adjustment bracket can be changed.

18. The press according to claim 3, wherein the pulling means is attached to an adjustment bracket arranged on the frame in a movable manner, such that the position of the adjustment bracket can be changed.

19. The method according to claim 11, wherein the press comprises a plurality of hydraulic cylinders acting on the pulling means and connected to the same hydraulic pressure source to provide the pulling force.
